(19) United States
(12) Patent Application Publication
(10) Pub. No.: US 2024/0367960 A1
(43) Pub. Date: Nov. 7, 2024

(54) Autonomous Cargo Transport Vehicle

(71) Applicants: Derrick Legros, Thunder Bay (CA); Paul Legros, JR., Thunder Bay (CA)

(72) Inventors: Derrick Legros, Thunder Bay (CA); Paul Legros, JR., Thunder Bay (CA)

(21) Appl. No.: 18/647,783

(22) Filed: Apr. 26, 2024

Related U.S. Application Data
(60) Provisional application No. 63/500,374, filed on May 5, 2023.

(51) Int. Cl. B66F 9/075

(52) U.S. Cl. CPC B66F 9/07568; B66F 9/07572; B66F 9/07581

(57) ABSTRACT

A transport vehicle has a front chassis section and a rear chassis section supported on respective steerable bogie frames with longitudinal and lateral suspension stabilizers. A recessed central chassis section between the front and rear sections supports a power source for powering drive motors on the bogie frames. A load supporting surface spans a full length of the vehicle over the front and rear bogie frames and the recessed power source therebetween. A controller autonomously controls the drive motors and the steering of the bogies to autonomously drive and steer the transport vehicle along a prescribed transport route stored on the autonomous controller, while supporting cargo ton the load supporting surface that can span the length of the vehicle or longer. Locating the wheels and power source within the footprint of the load supporting surface, allows the overall size of the vehicle to be minimized to improve transport economy.

This application claims the benefit under 35 U.S.C. 119 (e) of U.S. provisional application Ser. No. 63/500,374, filed May 5, 2023.

### FIELD OF THE INVENTION

The present invention relates to a vehicle for transporting cargo including self-propelled, steerable wheels and autonomous controls for autonomously transporting cargo over long distances and on varied terrain.

### BACKGROUND

The transportation of various cargo and goods is increasingly expensive due to increasing costs of fuel, increasing demand for skilled drivers, and other challenges related to different environments where cargo is to be transported. For example, in the forest industry, transportation of wood from cutting areas in the bush to roadways may require highly skilled drivers to navigate poor road conditions in the bush. In another example of transporting cargo, seasonal ice roads are used to transport cargo by land within a short transport season while the ground remains frozen, but as a result of climate change the condition of the ice roads is becoming less predicable and the transport season is becoming shorter so that transportation costs are increasing while becoming more dangerous for drivers.

### SUMMARY OF THE INVENTION

The present invention provides an autonomous self-propelled trailer for ice-roads, off-road and on-road, capable of moving all sorts of commodities from building materials, petroleum, construction, mining, electronic, consumables, and forest products. The invention is a self-propelled unit with an elongated chassis with drive wheels at each end powered by a power source located in the mid-section of the drop frame chassis. It will carry the load/deck above the chassis supported on each end of the chassis. These units can also be equipped with permanent fixtures for various commodities. There will be hydraulic motors powering the hubs/wheels for single or tandem bogie tires or track system application on each end with a continuous rotating motor/turntable for maneuvering and steering. No provisions are made for an onboard operator. The unit can be equipped with outboard pontoons or other floatation devices to prevent sinking in the event of the unit breaking through the ice. The unit will be propelled by petroleum/petrol motor, electric, battery, or solar power coupled with electronic devices such as computers, computer chips, GPS, remote control, satellite, drone, or cameras. These units can be platooned with multiple other units electronically to move a greater amount of product in short or long-distance hauls with little or no human assistance. This is safer in dangerous situations, for example ice roads.

This invention will solve the need for specialty drivers or personnel to move much needed products for all industries including ice roads which are becoming more dangerous and unpredictable with global warming. Platooning is the wave of the future, also, no need for logbooks as humans are subject to 14 hour days. These units will also consume less than half of the power source to move the same weights as the present trucks and trailers do. The forest industry is also facing a shortage of skilled drivers and drivers in general. These off-road units do not require a road either. They can transport the wood to road side instead of trucks coming all the way in the bush. Less people are needed in all aspects of each industry. 24 hour/7 days a week movement of products. This unit comes in various sizes to accommodate each industry's needs, ranging from 20,000 lbs and up.

According to one aspect of the invention there is provided a transport vehicle comprising:
a vehicle frame having a load supporting surface arranged to support cargo thereon, the load supporting surface spanning substantially a full length of the vehicle in a longitudinal direction of the vehicle frame between a front end and a rear end of the vehicle, and the load supporting surface spanning substantially a full width of the vehicle in a lateral direction of the vehicle frame between two sides of the vehicle;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels; and
an autonomous controller arranged to autonomously actuate said at least one drive motor and the steering drive so as to be arranged to autonomously drive and steer the transport vehicle along a prescribed transport route stored on the autonomous controller.

By arranging the load supporting surface (for example a cargo deck) to span a full length and a full width of the vehicle, with the wheels and power source contained within the longitudinal and lateral boundaries of the load supporting surface, the overall size of the vehicle can be minimized to improve efficiency and economy of transporting goods.

The vehicle frame may comprise a vehicle chassis having (i) a front chassis section supported on the front wheels, (ii) a rear chassis section supported on the rear wheels, and (iii) a central chassis section extending longitudinally between the front chassis section and the rear chassis section, wherein the central chassis section is lower in elevation than the front chassis section and the rear chassis section, and wherein the power source is supported above the central chassis section longitudinally between the front chassis section and the rear chassis section.

The vehicle frame may further comprise (i) a vehicle chassis supporting the power source thereon in which the vehicle chassis is supported on the front wheels and the rear wheels, and (ii) a deck frame supported on the vehicle chassis in which the deck frame defines the load supporting surface thereon.

Preferably the deck frame is longitudinally slidable relative to the vehicle chassis between a working position in fixed relation with the vehicle chassis for supporting cargo thereon for transport with the vehicle chassis and a loading position in which the deck frame is removed from the vehicle chassis for loading cargo onto the deck frame.

A plurality of rollers may be supported on the vehicle chassis in which the rollers support the deck frame for longitudinal sliding movement relative to the vehicle chassis between the working position and the loading position.

The vehicle chassis may include a central chassis section extending longitudinally between a front chassis section of the vehicle chassis supported on the front wheels and a rear chassis section of the vehicle chassis supported on the rear wheels, in which the central chassis section is lower in elevation than the front and rear chassis sections and support the power source thereon, and in which the rollers include (i) rear rollers supported on the rear chassis section, (ii) front rollers supported the front chassis section, and (iii) intermediate rollers supported spaced above the central chassis section.

The vehicle may further include at least one steerable bogie frame which is pivotal relative to the vehicle frame about a respective upright steering axis, in which said at least one steerable bogie frame supports at least one of the front wheels or the rear wheels thereon such that said at least one of the front wheels or the rear wheels are the steerable wheels.

Preferably the vehicle includes both (i) a front steerable bogie frame supporting the front wheels thereon for said steering movement together about the respective upright steering axis of the front steerable bogie frame, and (ii) a rear steerable bogie frame supporting the rear wheels thereon for said steering movement together about the respective upright steering axis of the rear steerable bogie frame.

Each steerable bogie frame may be pivotal relative to the vehicle frame through a range of at least 180 degrees.

Preferably each steerable bogie frame is fully rotatable relative to the vehicle frame through a range of 360 degrees.

When said at least one steerable bogie frame includes a respective intermediate frame which is pivotal relative to the steerable bogie frame about a longitudinal axis oriented in a rolling direction of the wheels of the steerable bogie frame, the wheels of said at least one steerable bogie frame may include at least one first wheel and at least one second wheel supported on laterally opposing sides of the respective intermediate frame, in which at least one lateral stabilizer is operatively connected between the steerable bogie frame and the respective intermediate frame. The lateral stabilizer may comprise a hydraulic piston cylinder arrangement.

When said at least one first wheel comprises two front wheels supported on the respective at least one steerable bogie frame and said at least one second wheel comprises two second wheels supported on the respective at least one steerable bogie frame, said at least one steerable bogie frame may include a respective first rocker frame supporting the front wheels at longitudinally spaced positions thereon and a respective second rocker frame supporting the two rear wheels at longitudinally spaced positions thereon in which the first and second rocker frames are pivotal relative to the intermediate frame about a lateral axis oriented perpendicularly to the longitudinal axis of the steerable bogie frame. Two longitudinal stabilizers may be operatively connected between each rocker frame and the steerable bogie frame at longitudinally spaced positions, in which each longitudinal stabilizer comprises a hydraulic piston cylinder arrangement.

The drive motor may be a hydraulic motor, in which the power source comprises a hydraulic pump, an internal combustion engine for driving the hydraulic pump, and a fuel tank for supplying fuel to the internal combustion engine. Preferably the hydraulic pump, the internal combustion engine and the fuel tank of the power source are commonly supported on the vehicle frame below the load supporting surface longitudinally between the front wheels and the rear wheels.

The vehicle may further comprise a pair of floatation pontoons arranged to be releasably mounted onto the two sides of the vehicle frame respectively.

According to a second aspect of the present invention there is provided a transport vehicle comprising:
a vehicle frame extending in a longitudinal direction of the vehicle frame between a front end and a rear end of the vehicle and extending in a lateral direction of the vehicle frame between two sides of the vehicle, the vehicle frame having a load supporting surface arranged to support cargo thereon;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels; and
an autonomous controller arranged to autonomously actuate said at least one drive motor and the steering drive so as to be arranged to autonomously drive and steer the transport vehicle along a prescribed transport route stored on the autonomous controller;
wherein the vehicle frame comprises a vehicle chassis having (i) a front chassis section supported on the front wheels, (ii) a rear chassis section supported on the rear wheels, and (iii) a central chassis section extending longitudinally between the front chassis section and the rear chassis section, wherein the central chassis section is lower in elevation than the front chassis section and the rear chassis section, and wherein the power source is supported above the central chassis section longitudinally between the front chassis section and the rear chassis section.

The arrangement of the chassis provides optimal weight distribution while minimizing the footprint of the vehicle to efficiently transport various types of cargo over long distances.

According to the preferred embodiment, said at least one drive motor is a hydraulic motor, wherein the power source comprises (i) a hydraulic pump, (ii) an internal combustion engine for driving the hydraulic pump, and (iii) a fuel tank for supplying fuel to the internal combustion engine, and wherein the hydraulic pump, the internal combustion engine and the fuel tank of the power source are commonly supported on the vehicle frame below the load supporting surface longitudinally between the front wheels and the rear wheels.

According to a further aspect of the present invention there is provided a transport vehicle comprising:
a vehicle frame extending in a longitudinal direction of the vehicle frame between a front end and a rear end of the vehicle and extending in a lateral direction of the vehicle frame between two sides of the vehicle, the vehicle frame having a load supporting surface arranged to support cargo thereon;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels;
an autonomous controller arranged to autonomously actuate said at least one drive motor and the steering drive so as to be arranged to autonomously drive and steer the transport vehicle along a prescribed transport route stored on the autonomous controller; and
at least one steerable bogie frame which is pivotal relative to the vehicle frame about a respective upright steering axis through a range of at least 180 degrees, said at least one steerable bogie frame supporting at least one of the front wheels or the rear wheels thereon such that said at least one of the front wheels or the rear wheels are the steerable wheels.

Preferably said at least one steerable bogie frame comprises (i) a front steerable bogie frame supporting the front wheels thereon for said steering movement together about the respective upright steering axis of the front steerable bogie frame, and (ii) a rear steerable bogie frame supporting the rear wheels thereon for said steering movement together about the respective upright steering axis of the rear steerable bogie frame.

This arrangement allows the vehicle frame to translate across the ground in any direction while also improving cornering ability, particularly when transporting very long loads.

According to the illustrated embodiment, said at least one steerable bogie frame includes a respective intermediate frame which is pivotal relative to the steerable bogie frame about a longitudinal axis oriented in a rolling direction of the wheels of the steerable bogie frame. Furthermore, in this instance, the wheels of said at least one steerable bogie frame include at least one first wheel and at least one second wheel supported on laterally opposing sides of the respective intermediate frame, and said at least one steerable bogie frame includes at least one lateral stabilizer operatively connected between the steerable bogie frame and the respective intermediate frame in which said at least one lateral stabilizer comprises a hydraulic piston cylinder arrangement.

Also according to the illustrated embodiment, said at least one first wheel comprises two front wheels supported on the respective at least one steerable bogie frame and said at least one second wheel comprises two second wheels supported on the respective at least one steerable bogie frame. In this instance, said at least one steerable bogie frame includes a respective first rocker frame supporting the front wheels at longitudinally spaced positions thereon and a respective second rocker frame supporting the two rear wheels at longitudinally spaced positions thereon in which the first and second rocker frames are pivotal relative to the intermediate frame about a lateral axis oriented perpendicularly to the longitudinal axis of the steerable bogie frame. In addition, said at least one steerable bogie frame includes two longitudinal stabilizers operatively connected between each rocker frame and the steerable bogie frame at longitudinally spaced positions, in which each longitudinal stabilizer comprises a hydraulic piston cylinder arrangement.

### BRIEF DESCRIPTION OF THE DRAWINGS

Various embodiments of the invention will now be described in conjunction with the accompanying drawings in which:

FIG. 1 is a side elevational view of the transport vehicle with the deck frame shown partially removed;

FIG. 2 is a side elevational view of the vehicle chassis;

FIG. 3 is a side elevational view of guide rollers supported on the chassis for guiding movement of the deck frame relative to the chassis as the deck frame is mounted onto or removed from the vehicle chassis;

FIG. 4 is a side elevational view of the front steerable bogie frame illustrating dual or single wheel options;

FIG. 5 is a side elevational view of the rear steerable bogie frame illustrating dual or single wheel options;

FIG. 6 is a schematic representation of either steerable bogie frame with some of the wheels removed for illustrating the stabilizer system;

FIG. 7 is a perspective view of a hydraulic winch for loading and unloading the deck frame relative to the vehicle frame;

FIG. 8 is a side view of a deck locking device for selectively locking the deck frame fixed onto the vehicle frame in a working position for transport;

FIG. 9 is rear elevational view of one of the pontoon members and a corresponding mounting bracket for selectively mounting the pontoon member onto a respective side of the vehicle frame;

FIGS. 10A and 10B are rear and side elevational views of one of the steerable bogie frames illustrating both lateral and longitudinal stabilizers between the wheels and the bogie frame;

FIG. 11 is a schematic representation of various components providing inputs to the autonomous controller for collection of data to autonomously control navigation of the vehicle;

FIG. 12 is a side elevational view of the transport vehicle with the cargo frame shown removed for illustrative purposes;

FIG. 13 is a top view of one of the steerable bogie frames shown detached from the transport vehicle illustrating the slew bearing turntable with dual swing motors;

FIG. 14 is a schematic top view of the vehicle frame with the cargo frame shown removed for illustrative purposes; and

FIG. 15 is a schematic representation of the various operating components of the transport vehicle.

In the drawings like characters of reference indicate corresponding parts in the different figures.

### DETAILED DESCRIPTION

Referring to the accompanying figures there is illustrated an autonomous off-road cargo transport vehicle generally indicated by reference numeral 10. The vehicle 10 is autonomously controlled and configured to be capable of long-distance highway transport of goods on various roadways, including ice roads and the like, as well as being capable of transporting cargo on off-road terrain, for example bush trails communicating between highways and remote forestry logging areas.

The vehicle 10 generally includes a vehicle frame including a vehicle chassis 12 which supports a load bearing cargo frame 14 thereon, for example a deck frame as shown in the illustrated embodiment for supporting cargo thereon. The vehicle frame is supported on a set of front wheels 16 adjacent a front end of the vehicle frame and rear wheels 18 adjacent a rear end of the vehicle in which some or all the wheels are steerable relative to the vehicle frame via turntables described in further detail below. A set of drive motors 20 are operatively connected to respective ones of the wheels in a direct drive arrangement for driving rolling movement of the wheels along the ground. The vehicle 10 also includes an autonomous controller 22 providing autonomous control of the drive motors 20, steering of the wheels, and suspension of the wheels relative to the chassis so as to autonomously navigate the vehicle over various terrain and/or along a prescribed route stored on the controller.

The vehicle chassis 12 generally includes two longitudinal beams 24 extending substantially the full length of the vehicle in the longitudinal direction between the front end and the rear end of the vehicle. Several crossbars are structurally connected between the longitudinal beams to extend in a lateral direction perpendicularly to the longitudinal direction of the beams in connection between the beams.

The vehicle chassis is configured to define a front chassis section 28 adjacent the front end of the vehicle for extending over the front wheels 16, a rear chassis section 30 adjacent the rear end of the vehicle for extending over the rear wheels 18, and a central chassis section 32 extending longitudinally between the front chassis section 28 and the rear chassis section 30 at an intermediate location along the length of the vehicle. The central chassis section 32 is lower in elevation than the front and rear chassis sections such that a top end of the beams at the central chassis section 32 are spaced below bottom sides of the beams at the front and rear sections. The central chassis section 32 has a length in the longitudinal direction which is greater than either of the front section or the rear section such that the length of the central chassis section 32 in the illustrated embodiment is approximately equal to a combined length of the front and rear sections together.

In the illustrated embodiment, the cargo frame 14 comprises a deck frame which is removably supported on the vehicle chassis 12. More particularly, the deck frame is longitudinally slidable relative to the vehicle chassis for movement between a working position supported above the vehicle chassis, in fixed relation to the chassis for supporting cargo thereon for transport along a roadway, and a loading position in which the deck frame is removed from the vehicle chassis to be supported at ground level for loading cargo onto the cargo frame 14.

To facilitate loading and unloading of the deck frame 14 onto the vehicle chassis 12, a set of rollers are supported on the chassis to support the deck frame thereon such that the deck frame is longitudinally slidable by interaction of the rollers rolling along the underside of the deck frame between the working and loading positions of the deck frame. The set of rollers include a set of front rollers 34 supported at the top side of the front chassis section 28, rear rollers 36 supported at the top side of the rear chassis section 30, and intermediate rollers 38 supported at a location spaced above the central chassis section 32. More particularly, one or more upright frame members 40 are mounted centrally on the central chassis section 32 to extend upwardly from the central chassis section to support the intermediate rollers 38 at the top end thereof so that the intermediate rollers 38 rotate about respective lateral axes lying in a common plane with the lateral axes of the front rollers and the rear rollers respectively.

The deck frame 14 in this instance comprises a pair of longitudinally extending rails 42 supported for rolling contact on the rollers respectively, and crossbars 44 connected laterally between the longitudinal rails. A suitable decking material 46 is mounted on the top side of the crossbars 44 and/or rails 42 in which the decking material is formed of suitable sheet material ending the full width and full length of the deck frame which in turn spans the full width and the full length of the vehicle. The deck material has a top side defining a load supporting surface that is continuous across the full width and length of the vehicle for supporting the cargo thereon.

A winch 47 is mounted at the forward end of the vehicle frame for being operatively connected to the front end of the deck frame when the deck frame is in the loading position removed from the vehicle frame. Actuating the winch acts to pull the deck frame onto the vehicle frame from the rear end to the front end for loading the deck frame from the loading position to the working position on top of the vehicle frame. A set of latches 49 are provided for selectively locking the deck frame 14 in a fixed and immovable relationship relative to the vehicle frame. Both the winch and the latches include respective hydraulic actuators to actuate the winch and to engage or disengage the latches to either lock the deck frame mounted on the vehicle or release the deck frame to allow the deck frame to be displaced to the loading position.

In further embodiments, the deck frame 14 may be replaced with a variety of other suitable structures for securing and transporting cargo including various types of cargo boxes or containers for containing dry goods, or various types of vessels or receptacles for containing liquid goods therein for example.

In yet a further embodiment the cargo frame may comprise a plurality of U-shaped cradles at longitudinally spaced positions in which each U-shaped cradle includes a laterally extending bottom member and upright posts extending upward at opposing ends of the bottom member so as to be suitable for containing logs and the like extending in the longitudinal direction of the vehicle within the cradles respectively.

The vehicle 10 further includes a power source 48 which is mounted above the central chassis section of the vehicle chassis 12 such that a top end of the power source is near or spaced below the elevation of the rollers while being fully contained longitudinally between the front wheels at the front chassis section and the rear wheels at the rear chassis section and being fully contained laterally between opposing sides of the vehicle. In this manner the power source 48 does not interfere with displacement of the cargo frame 14 between working and loading positions relative to the vehicle frame.

In the illustrated embodiment, the power source 48 includes an internal combustion engine 50 supplied with fuel from a fuel tank 51 which are both supported on the central chassis section. The internal combustion engine 50 in this instance drives a hydraulic pump 52 that drives various hydraulic systems of the vehicle as described in further detail below. In this instance, the drive motors 20 mounted within the wheel hubs to directly drive the wheels of the vehicle preferably comprise hydraulic orbit motors supplied with pressurized hydraulic fluid from the pump 52 driven by the engine 50.

In further embodiments, the power source may comprise a battery providing power to an electric motor which drives the hydraulic pump 52 to supply power to all of the hydraulic operating components of the vehicle as described in further detail below.

In yet further embodiments, the drive motors 20 may comprise electric motors directly mounted in the wheel hubs so that the power source 48 in this instance comprises a battery (i) providing power to the electric drive motors that drive rotation of the wheels and (ii) providing power to an electric pump motor that drives the hydraulic pump to supply hydraulic power to any hydraulic operating components of the vehicle.

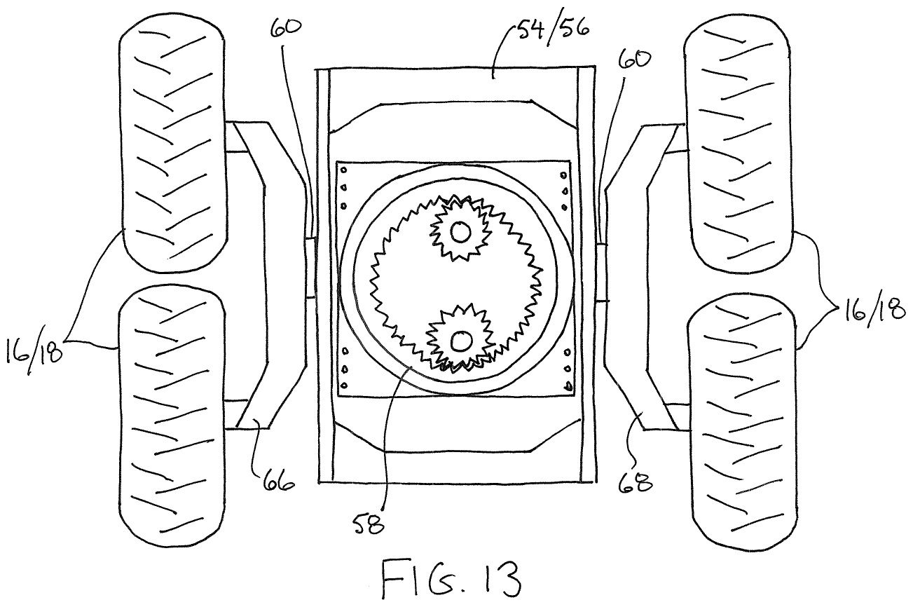

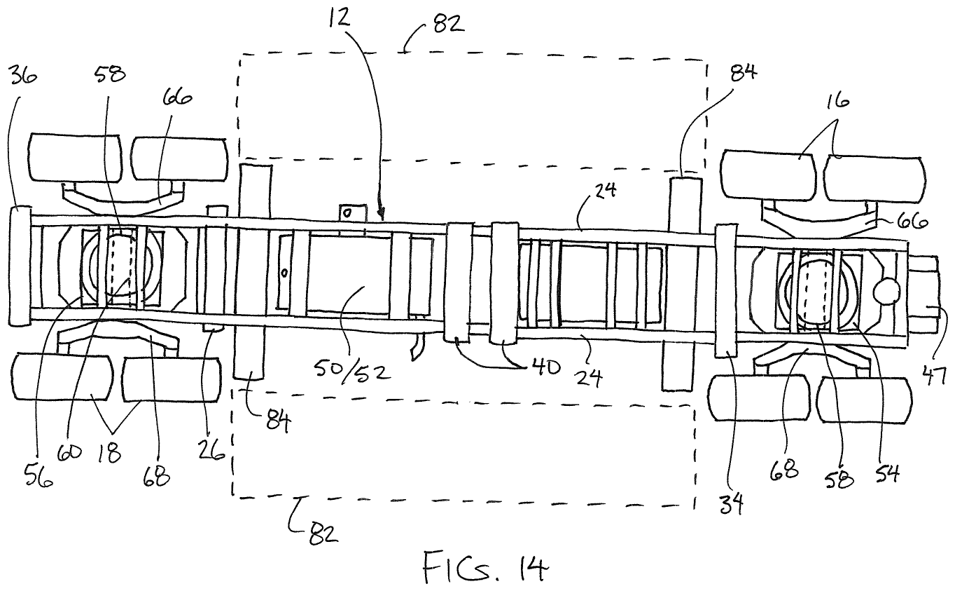

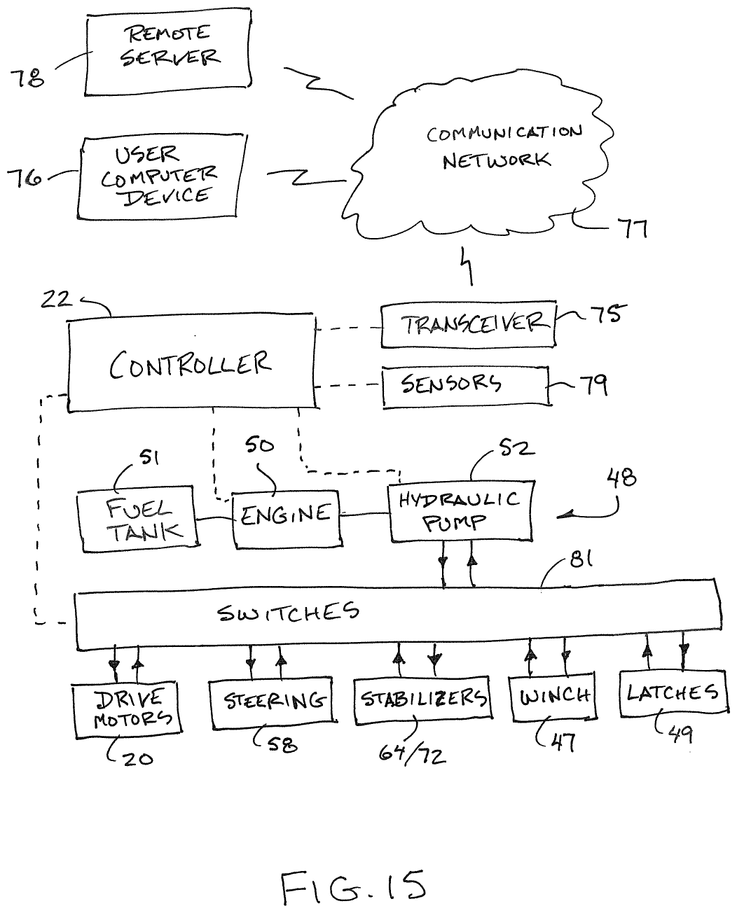

In the illustrated embodiment, both the front wheels 16 and the rear wheels 18 are arranged to be steered relative to the vehicle frame using a front steerable bogie frame 54 and a rear steerable bogie frame 56 respectively. Each bogie frame 54 and 56 is connected beneath the respective front chassis section 28 or rear chassis section 30 by a suitable slew drive including a turntable 58 that supports the bogie frame for rotation about a respective upright steering axis relative to the vehicle frame through a range of at least 180 degrees and preferably for full rotation about 360 degrees. Rotation of the bogie frames relative to the vehicle frame about the turntables 58 is controlled by dual hydraulic steering actuators associated with the turntable which enables the bogie frames to be controllably rotated in two opposing directions and precisely located angularly about the respective vertical steering axes relative to the vehicle frame. As shown in FIG. 13, the turntable includes an annular bearing supporting the bogie frame rotatably relative to the vehicle frame, a ring gear supported fixedly on one of the bogie frame or the vehicle frame, and a pair of spur gears meshing with the ring gear that are driven by the two hydraulic actuators or motors respectively mounted on the other one of the bogie frame or the vehicle frame to drive rotation of the bogie frame relative to the vehicle frame.

Each bogie frame 54 and 56 further includes an intermediate frame 60 mounted below the bogie frame in the form of a laterally extending beam which is mounted by a central pivot 62 on the bogie frame. The central pivot 62 supports the lateral beam for pivotal movement about a longitudinal axis oriented in the longitudinal direction of the vehicle when oriented for rolling movement in a forward working direction of the vehicle. In the forward working direction, the lateral beam of the intermediate frame 60 supports one or more first wheels among the front or rear wheels respectively at a first side of the bogie frame corresponding to a first end of the beam and supports one or more second wheels among the front or rear wheels respectively at a second side of the bogie frame corresponding to a second end of the beam. In this manner, elevation of the first wheels at the first side of the vehicle can vary relative to elevation of the second wheels at the second side of the vehicle as the vehicle is displaced over uneven terrain by pivoting of the lateral beam about the longitudinal axis of the central pivot 62.

A pair of lateral stabilizers 64 are connected between opposing ends of the lateral beam of the intermediate frame 60 respectively. Each lateral stabilizer 14 is a hydraulic piston cylinder arrangement which varies in length according to the volumes and pressures of hydraulic fluid within the cylinder. The stabilizers 64 are controlled by the hydraulic system of the vehicle for controlling the suspension of the wheels relative to the vehicle. Hydraulic fluid can be configured to flow between the two lateral stabilizers of each bogie frame in a controlled manner and to actively change the stiffness depending upon the driving mode of the vehicle including when cornering, driving over uneven terrain, or driving on level roadways.

In instances where only a single first wheel and a single second wheel are provided at opposing ends of the lateral beam to collectively define the front wheels of the vehicle or the rear wheels of the vehicle, the wheels would be typically directly supported on the lateral beam of the intermediate frame 60 with or without additional suspension elements therebetween such as a spring suspension or an airbag suspension for example.

According to the illustrated embodiments, each bogie frame supports two first wheels at the first side of the frame and two second wheels at the second side of the frame such that the set of front wheels 16 includes four wheels in a tandem axle configuration and the set of rear wheels 18 also includes four wheels in a tandem axle configuration. In this instance, each bogie frame 54 or 56 further includes a first rocker frame 66 and a second rocker frame 68 supported at opposing ends of the lateral beam of the intermediate frame 60. Each rocker frame 54 or 56 is a longitudinal beam extending in the longitudinal direction of the vehicle when the vehicle is arranged for rolling in the forward working direction. Each rocker frame 66 and 68 is pivotal relative to the intermediate frame 60 about a respective lateral axis oriented perpendicularly to the longitudinal axis of the intermediate frame. Each rocker frame is supported by a respective pivot 70 centrally located along a length of the rocker frame for pivotally mounting the rocker frame at a central location on the respective end of the lateral beam of the intermediate frame 60. The two first wheels of the bogie frame are supported at longitudinally opposed ends of the first rocker frame 66 and the two second wheels of the bogie frame are supported at longitudinally opposed ends of the second rocker frame 68 so that all of the wheels are rotatable about respective wheel axes that are parallel to one another and parallel to the lateral axes of the rocker frames. In this manner, each rocker frame functions as a walking beam for rolling over various changes in elevation in the ground.

A pair of longitudinal stabilizers 72 are associated with each rocker frame 66 and 68 of each bogie frame 54 and 56. The longitudinal stabilizers 72 of each rocker frame are operatively connected between the ends of the rocker frame respectively and one of the intermediate frame 60 or the bogie frame. Each longitudinal stabilizer comprises a hydraulic piston cylinder arrangement which varies in length according to the volumes and pressures of hydraulic fluid within the cylinder. The stabilizers 72 are controlled by the hydraulic system of the vehicle for controlling the suspension of the wheels relative to the vehicle. Hydraulic fluid can be configured to flow between the stabilizers of each rocker frame in a controlled manner and to actively change the stiffness depending upon the driving mode of the vehicle including when cornering, driving over uneven terrain, or driving on level roadways.

The autonomous controller 22 includes a computer processor and a memory storing programming instructions thereon and arranged to be executed by the processor to perform the various functions described herein. The controller is further arranged to store a prescribed route to be travelled by the vehicle. A communication antenna or transceiver 75 is operatively connected to the autonomous controller to enable wireless communication of the controller over a suitable communications network 77 with various systems including a user computer device 76 or a remote server 78 so that the controller can receive instructions from the server or the user device as well as send reporting data to the user device or the server during operation.

The controller is further configured to receive data input from various sources 79 including (i) sensors which can sense objects in the surrounding environment, weather conditions, or movement of the vehicle using accelerometers or gyroscopes and the like, (ii) cameras which can capture image data relating to the surrounding environment, (iii) GPS equipment for communicating with global positioning satellites to determine location of the vehicle, and (iv) other sensors or imaging systems capable of mapping the surrounding environment such as radar or lidar systems and the like. The controller uses the various inputs together with stored maps and other stored navigation data to plot a course for the vehicle. The controller further generates a list of instructions to control the various systems of the vehicle by controlling hydraulic switches 81 associated with steering by the turntable actuators, drive of the wheels by the motors, and suspension provided by the longitudinal stabilizers 72 and the lateral stabilizers 64 to control the speed and drive the vehicle appropriately so that the vehicle follows the plotted course or prescribed route stored on the controller.

When used on ice roads, the vehicle 10 may be further provided with a set of pontoons 82 which are releasably mounted onto the opposing sides of the vehicle by suitable mounting brackets 84. The mounting brackets 84 protrude laterally outward from opposing sides of the vehicle chassis at longitudinally spaced positions so that two or more brackets are provided on each side of the vehicle for securing one or more pontoons 82 extending longitudinally along each side of the vehicle. Each pontoon member 82 is an elongated sealed tube filled with air or a solid material having a density less than water such that the pontoon member is buoyant and provides flotation to support the weight of the vehicle and cargo supported on the vehicle buoyantly in a body of water. One or more pontoon members span the majority of the length of the vehicle along each side of the vehicle to support the vehicle buoyantly in a stable manner. The pontoons 82 are particularly useful when the vehicle is used for transporting goods across ice roads to safely support the vehicle buoyantly in a body of water in the event of the vehicle breaking through the ice during transport. The mounting brackets 84 are arranged to be readily releasable so as to enable the pontoons to be released from the vehicle when not in use.

As described herein, the unit is self-propelled with no onboard driver/operator. It has an elongated body and is capable of loading and unloading the laden or unladen roll-off decks with an onboard winch. This unit can also be fitted with permanent fixtures to the chassis for various commodities. It has hydraulic driven bogie systems “single or tandem” with tires or tracks at each end controlled by a power source in the center of the chassis. This power source is activated remotely by computers, computer chips, GPS, remote control, satellite, drone, or cameras. Previous applications have onboard operators, or designed for moving large, heavy objects on hard ground and at a very slow pace. They are not designed for high productivity or long-distance hauling. Previous units were designed product specific. They are usually heavier and more expensive with cab and controls.

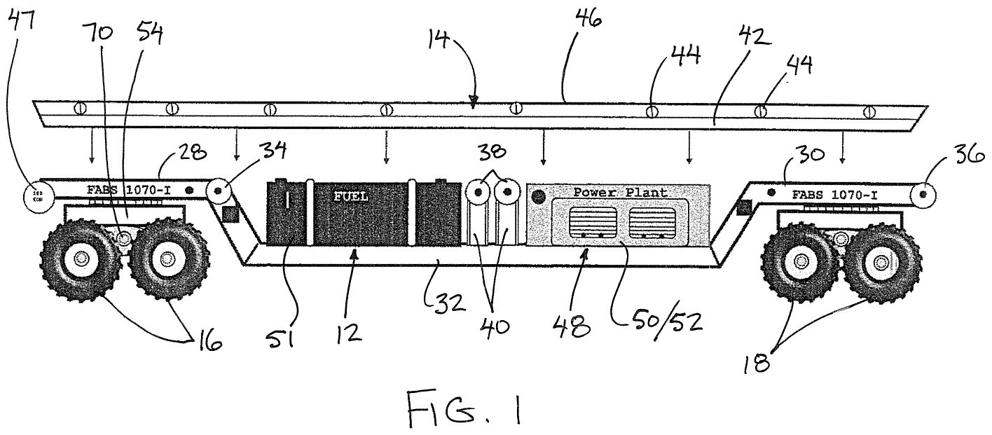

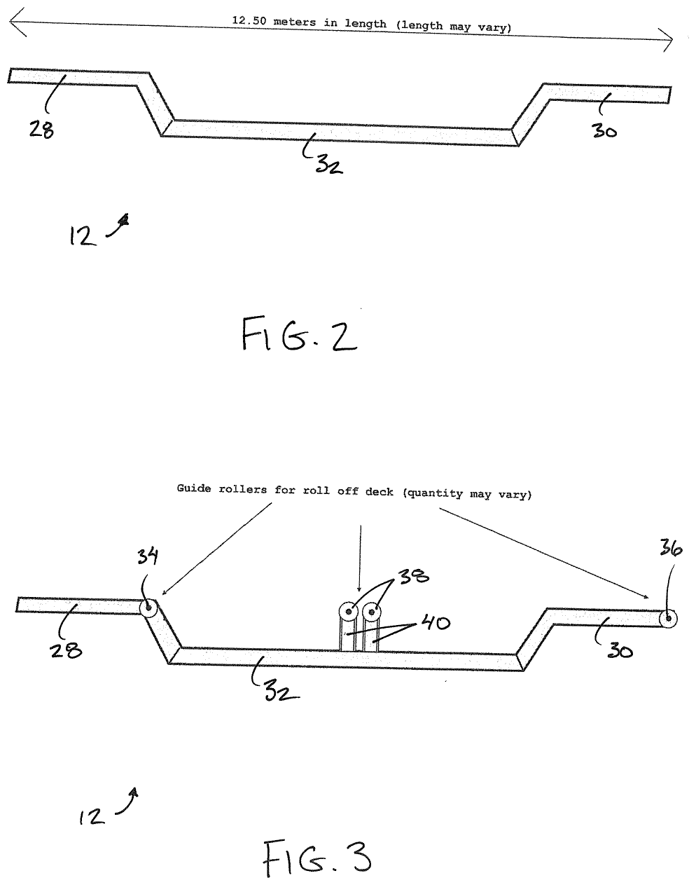

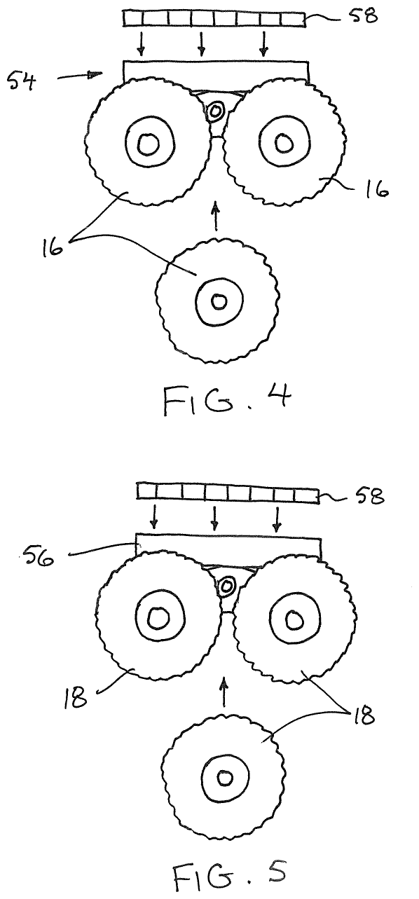

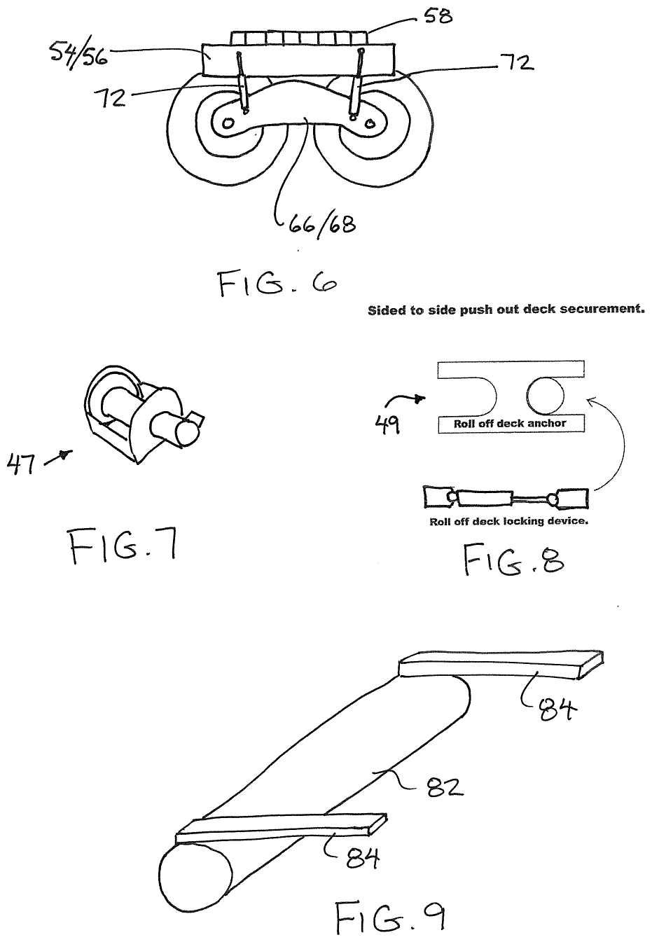

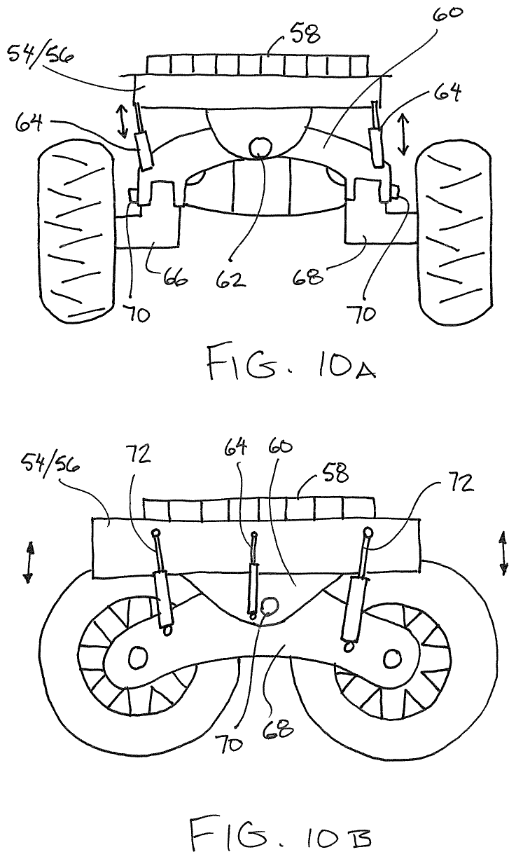

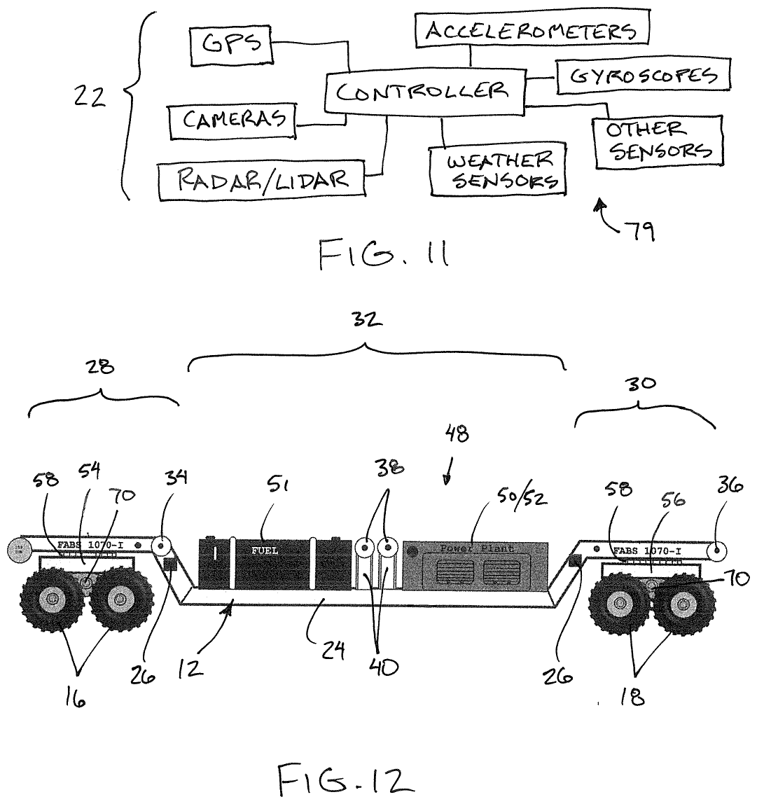

FIG. 1 shows a self-propelled unit according to the present invention. FIG. 2 shows the frame/chassis as a ¾″×5″ T-100 flange with 10½″× 5/16 high tensile steel web, 1.12 meters wide, in which the unit is 12.50 meters in length (but length may vary), is 3.048 meters wide (width may vary) and is 1.830 meters high (height may vary). FIG. 3 shows a center load-bearing point with a roll-off roller attached that is 0.915 meters high. FIG. 4 shows the bogies that have a tandem or single hydraulic driven suspension system. FIG. 6 shows a front bogie suspension system that has hydraulic cylinder fore and aft stabilizer when turning 90 degrees. FIG. 10 shows the rear bogie suspension system has a pivoting side to side hydraulic cylinder stabilizer and a fore and aft hydraulic cylinder for stabilizing when turning 90 degrees. The bogie turning system front and back are fitted with a slew driven turntable with the front and rear suspensions as shown in FIG. 13. FIG. 5 shows that there are sub frames that attach the hydraulic driven suspension to each turn table. FIG. 12 shows the vehicle can be equipped with various power sources to power the hydraulic pump. FIG. 7 shows an example of a hydraulic winch for the self-loading/unloading feature. FIG. 3 shows guide rollers for the roll-off deck. FIG. 8 shows locking devices to adequately hold the roll-off deck secure to the unit once loaded. FIG. 11 illustrates various autonomous devices of all types for mobility of the unit or units for different applications. FIG. 9 shows an optional bracket for mounting sufficient floatation devices if needed for ice-road traveling.

Since various modifications can be made in the invention as herein above described, and many apparently widely different embodiments of same made, it is intended that all matter contained in the accompanying specification shall be interpreted as illustrative only and not in a limiting sense.

1. A transport vehicle comprising:
a vehicle frame having a load supporting surface arranged to support cargo thereon, the load supporting surface spanning substantially a full length of the vehicle in a longitudinal direction of the vehicle frame between a front end and a rear end of the vehicle, and the load supporting surface spanning substantially a full width of the vehicle in a lateral direction of the vehicle frame between two sides of the vehicle;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels; and
an autonomous controller arranged to autonomously actuate said at least one drive motor and the steering drive so as to be arranged to autonomously drive and steer the transport vehicle along a prescribed transport route stored on the autonomous controller.

2. The vehicle according to claim 1 wherein the vehicle frame comprises a vehicle chassis having (i) a front chassis section supported on the front wheels, (ii) a rear chassis section supported on the rear wheels, and (iii) a central chassis section extending longitudinally between the front chassis section and the rear chassis section, wherein the central chassis section is lower in elevation than the front chassis section and the rear chassis section, and wherein the power source is supported above the central chassis section longitudinally between the front chassis section and the rear chassis section.

3. The vehicle according to claim 1 wherein the vehicle frame comprises (i) a vehicle chassis supporting the power source thereon in which the vehicle chassis is supported on the front wheels and the rear wheels, and (ii) a deck frame supported on the vehicle chassis in which the deck frame defines the load supporting surface thereon.

4. The vehicle according to claim 3 wherein the deck frame is longitudinally slidable relative to the vehicle chassis between a working position in fixed relation with the vehicle chassis for supporting cargo thereon for transport with the vehicle chassis and a loading position in which the deck frame is removed from the vehicle chassis for loading cargo onto the deck frame.

5. The vehicle according to claim 4 further comprising a plurality of rollers supported on the vehicle chassis in which the rollers support the deck frame for longitudinal sliding movement relative to the vehicle chassis between the working position and the loading position.

6. The vehicle according to claim 5 wherein the vehicle chassis includes a central chassis section extending longitudinally between a front chassis section of the vehicle chassis supported on the front wheels and a rear chassis section of the vehicle chassis supported on the rear wheels, in which the central chassis section is lower in elevation than the front and rear chassis sections and support the power source thereon, and in which the rollers include (i) rear rollers supported on the rear chassis section, (ii) front rollers supported the front chassis section, and (iii) intermediate rollers supported spaced above the central chassis section.

7. The vehicle according to claim 1 further comprising at least one steerable bogie frame which is pivotal relative to the vehicle frame about a respective upright steering axis, said at least one steerable bogie frame supporting at least one of the front wheels or the rear wheels thereon such that said at least one of the front wheels or the rear wheels are the steerable wheels.

8. The vehicle according to claim 7 wherein said at least one steerable bogie frame comprises (i) a front steerable bogie frame supporting the front wheels thereon for said steering movement together about the respective upright steering axis of the front steerable bogie frame, and (ii) a rear steerable bogie frame supporting the rear wheels thereon for said steering movement together about the respective upright steering axis of the rear steerable bogie frame.

9. The vehicle according to claim 7 wherein said at least one steerable bogie frame is pivotal relative to the vehicle frame through a range of at least 180 degrees.

10. The vehicle according to claim 7 wherein said at least one steerable bogie frame is fully rotatable relative to the vehicle frame through a range of 360 degrees.

11. The vehicle according to claim 7 wherein:
said at least one steerable bogie frame includes a respective intermediate frame which is pivotal relative to the steerable bogie frame about a longitudinal axis oriented in a rolling direction of the wheels of the steerable bogie frame;
the wheels of said at least one steerable bogie frame include at least one first wheel and at least one second wheel supported on laterally opposing sides of the respective intermediate frame; and
said at least one steerable bogie frame includes at least one lateral stabilizer operatively connected between the steerable bogie frame and the respective intermediate frame;
said at least one lateral stabilizer comprising a hydraulic piston cylinder arrangement.

12. The vehicle according to claim 11 wherein:
said at least one first wheel comprises two front wheels supported on the respective at least one steerable bogie frame and said at least one second wheel comprises two second wheels supported on the respective at least one steerable bogie frame;
said at least one steerable bogie frame includes a respective first rocker frame supporting the front wheels at longitudinally spaced positions thereon and a respective second rocker frame supporting the two rear wheels at longitudinally spaced positions thereon in which the first and second rocker frames are pivotal relative to the intermediate frame about a lateral axis oriented perpendicularly to the longitudinal axis of the steerable bogie frame;
said at least one steerable bogie frame includes two longitudinal stabilizers operatively connected between each rocker frame and the steerable bogie frame at longitudinally spaced positions; and
each longitudinal stabilizer comprises a hydraulic piston cylinder arrangement.

13. The vehicle according to claim 1 wherein said at least one drive motor is a hydraulic motor, wherein the power source comprises a hydraulic pump, an internal combustion engine for driving the hydraulic pump, and a fuel tank for supplying fuel to the internal combustion engine, and wherein the hydraulic pump, the internal combustion engine and the fuel tank of the power source are commonly supported on the vehicle frame below the load supporting surface longitudinally between the front wheels and the rear wheels.

14. The vehicle according to claim 1 further comprising a pair of floatation pontoons arranged to be releasably mounted onto the two sides of the vehicle frame respectively.

15. A transport vehicle comprising:
a vehicle frame extending in a longitudinal direction of the vehicle frame between a front end and a rear end of the vehicle and extending in a lateral direction of the vehicle frame between two sides of the vehicle, the vehicle frame having a load supporting surface arranged to support cargo thereon;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels; and
an autonomous controller arranged to autonomously actuate said at least one drive motor and the steering drive so as to be arranged to autonomously drive and steer the transport vehicle along a prescribed transport route stored on the autonomous controller;
wherein the vehicle frame comprises a vehicle chassis having (i) a front chassis section supported on the front wheels, (ii) a rear chassis section supported on the rear wheels, and (iii) a central chassis section extending longitudinally between the front chassis section and the rear chassis section, wherein the central chassis section is lower in elevation than the front chassis section and the rear chassis section, and wherein the power source is supported above the central chassis section longitudinally between the front chassis section and the rear chassis section.

16. The vehicle according to claim 15 wherein said at least one drive motor is a hydraulic motor, wherein the power source comprises a hydraulic pump, an internal combustion engine for driving the hydraulic pump, and a fuel tank for supplying fuel to the internal combustion engine, and wherein the hydraulic pump, the internal combustion engine and the fuel tank of the power source are commonly supported on the vehicle frame below the load supporting surface longitudinally between the front wheels and the rear wheels.

17. A transport vehicle comprising:
a vehicle frame extending in a longitudinal direction of the vehicle frame between a front end and a rear end of the vehicle and extending in a lateral direction of the vehicle frame between two sides of the vehicle, the vehicle frame having a load supporting surface arranged to support cargo thereon;
a plurality of front wheels and a plurality of rear wheels supported below the vehicle frame in proximity to the front end and the rear end of the vehicle respectively so as to be arranged for rolling movement in the longitudinal direction, the front wheels and the rear wheels between located longitudinally between the front end and the rear end of the vehicle;
at least one drive motor operatively connected to at least some of the wheels so as to be arranged to drive the rolling movement of the wheels;
a power source arranged to supply power to the at least one drive motor, the power source being located below the load supporting surface between the front wheels and the rear wheels;
at least some of the wheels being steerable wheels arranged to be pivoted relative to the vehicle frame in a steering movement;
a steering drive associated with the steerable wheels for driving the steering movement of the steerable wheels;
an autonomous controller arranged to autonomously actuate said at least one drive motor and the steering drive so as to be arranged to autonomously drive and steer the transport vehicle along a prescribed transport route stored on the autonomous controller; and
at least one steerable bogie frame which is pivotal relative to the vehicle frame about a respective upright steering axis through a range of at least 180 degrees, said at least one steerable bogie frame supporting at least one of the front wheels or the rear wheels thereon such that said at least one of the front wheels or the rear wheels are the steerable wheels.

18. The vehicle according to claim 17 wherein said at least one steerable bogie frame comprises (i) a front steerable bogie frame supporting the front wheels thereon for said steering movement together about the respective upright steering axis of the front steerable bogie frame, and (ii) a rear steerable bogie frame supporting the rear wheels thereon for said steering movement together about the respective upright steering axis of the rear steerable bogie frame.

19. The vehicle according to claim 17 wherein:
said at least one steerable bogie frame includes a respective intermediate frame which is pivotal relative to the steerable bogie frame about a longitudinal axis oriented in a rolling direction of the wheels of the steerable bogie frame;
the wheels of said at least one steerable bogie frame include at least one first wheel and at least one second wheel supported on laterally opposing sides of the respective intermediate frame; and
said at least one steerable bogie frame includes at least one lateral stabilizer operatively connected between the steerable bogie frame and the respective intermediate frame;
said at least one lateral stabilizer comprising a hydraulic piston cylinder arrangement.

20. The vehicle according to claim 19 wherein:
said at least one first wheel comprises two front wheels supported on the respective at least one steerable bogie frame and said at least one second wheel comprises two second wheels supported on the respective at least one steerable bogie frame;
said at least one steerable bogie frame includes a respective first rocker frame supporting the front wheels at longitudinally spaced positions thereon and a respective second rocker frame supporting the two rear wheels at longitudinally spaced positions thereon in which the first and second rocker frames are pivotal relative to the intermediate frame about a lateral axis oriented perpendicularly to the longitudinal axis of the steerable bogie frame;
said at least one steerable bogie frame includes two longitudinal stabilizers operatively connected between each rocker frame and the steerable bogie frame at longitudinally spaced positions; and
each longitudinal stabilizer comprises a hydraulic piston cylinder arrangement.
